(19) United States
(12) Patent Application Publication
(10) Pub. No.: US 2016/0189474 A1
(43) Pub. Date: Jun. 30, 2016

(54) SYSTEMS AND METHODS FOR GENERATING AND STREAMING GAME DATA TO A GROUP MEDIA CLIENT AND A PLURALITY OF PERSONAL MEDIA CLIENTS

(71) Applicant: SLING MEDIA INC., Foster City, CA (US)

(72) Inventors: Babak Zamani, Mountain View, CA (US); Oleksandr Yegorov, Foster City, CA (US); Yash Suresh Shah, San Mateo, CA (US)

(21) Appl. No.: 14/983,917

(22) Filed: Dec. 30, 2015

Related U.S. Application Data
(60) Provisional application No. 62/098,529, filed on Dec. 31, 2014.

(51) Int. Cl. G07F 17/32

(52) U.S. Cl. CPC G07F 17/3227; G07F 17/3241; G07F 17/3293

(57) ABSTRACT

Systems and processes for streaming a game to a group media client and a plurality of personal media clients are disclosed. In various embodiments, a media streaming device and game processor may execute game software or game logic to generate game data. This game data may be streamed for display to each game player as a group to a group media client as well as over a network to a personal media client of each individual player. Each player may select game data (e.g., a card or cards in the case of the game of poker), and this selection may be communicated to the media streaming device and game processor over the network. The media streaming device and game processor may, in response, continue to execute the game logic to generate updated game data.

### CROSS-REFERENCE TO RELATED APPLICATIONS

This Application claims the benefit of priority to U.S. Provisional Application Ser. No. 62/098,526, filed on Dec. 31, 2014, the contents of which are herein incorporated by reference in their entirety.

### TECHNICAL FIELD

The present disclosure generally relates to the generation and streaming of digital media content, and more particularly to the generation and streaming of game data associated with a game to a plurality of media clients.

### BACKGROUND

In general, media streaming devices are those that allow content to be streamed from a media source device (e.g., a DVR or television set top box) to a media client (e.g., a computer or a mobile communication device). Typically a media streaming device acts as a real time encoder that streams content from the media source device to the media client. Some media streaming devices are referred to as “placeshifting” devices. These devices may encode a media stream for streaming to a media client. An example placeshifting device is described in U.S. Published Patent Application No. 2006/0095471, entitled PERSONAL MEDIA BROADCASTING SYSTEM, filed Jun. 7, 2005, which is hereby incorporated by reference in its entirety.

A variety of games are offered for upload and installation to personal media clients, such as, for example, the game of poker. These games may permit players to interact, via a network server or game server, with each other in order to play the game. Conventionally, however, many instances of the game logic may reside on each of the personal media clients coupled to the game server, thus requiring that each personal media client utilize its processor to execute the game logic. Moreover, although certain information about the actions of other game players (e.g., card selections) may be displayed by the personal media clients individually, a group display, visible to each of the game players, is not typically part of the game experience.

Accordingly, systems and methods that remove the game logic from each of a plurality of personal media clients are desirable. In addition, systems and methods that enable presentation of game data to each player of a game as a group are desirable.

### BRIEF DESCRIPTION

As described above, personal media clients have traditionally been enabled to upload and install game software (or logic) such as, for example, software for the game of poker. Game software may permit players to interact, via a network server or game server, with each other as each plays the game. Where game software is installed in this fashion, however, many instances of the game software may reside on each of the personal media clients coupled to the game server, and this may require that each personal media client utilize its internal processor to execute the game software. Moreover, although certain information about the actions of other game players (e.g., card selections) may be displayed for a player individually by player's personal media client, a group display, visible to each of the game players, may not typically extend into the game experience.

Accordingly, in various embodiments, systems and processes for streaming a game to a group media client and a plurality of personal media clients are disclosed. In various embodiments, a media streaming device and game processor may execute game software or game logic to generate game data. This game data may be streamed for display to each game player as a group to a group media client as well as over a network to a personal media client of each individual player. Each player may select game data (e.g., a card or cards in the case of the game of poker), and this selection may be communicated to the media streaming device and game processor over the network. The media streaming device and game processor may, in response, continue to execute the game logic to generate updated game data, and all or a portion of this updated data may be streamed to the group media client and/or one or more of the personal media clients.

Still other embodiments provide additional processes, systems and devices for streaming a game to a group media client and a plurality of personal media clients. The examples presented in this brief description may be modified or augmented in any manner, and many additional examples are described below.

### BRIEF DESCRIPTION OF THE DRAWING FIGURES

Exemplary embodiments will hereinafter be described in conjunction with the following drawing figures, wherein like numerals denote like elements, and

FIG. 1 shows, in accordance with various embodiments, a block diagram of a system for streaming a game to a group media client and a plurality of personal media clients;

FIG. 2 shows, in accordance with various embodiments, a process for streaming a game to a group media client and a plurality of personal media clients; and

FIG. 3 shows, in accordance with various embodiments, a three-dimensional representation of a system for streaming a game to a group media client and a plurality of personal media clients.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

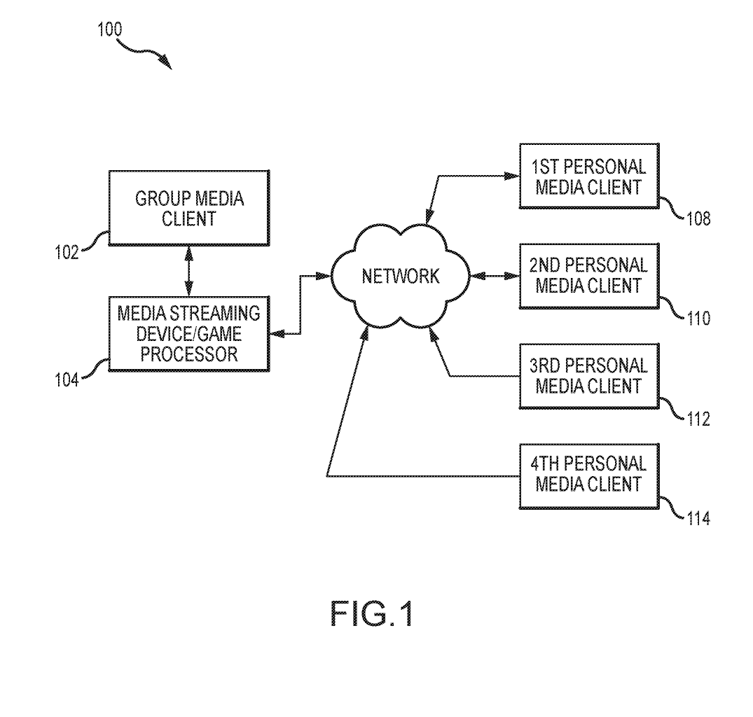

Turning now to the drawing figures, FIG. 1, a system 100 for streaming a game to a group media client and a plurality of personal media clients is shown. The system 100 may comprise a group media client 102, a media streaming device and game processor (“MSDGP”) 104, a network 106, and a plurality of personal media clients, such as personal media clients 108, 110, 112, and/or 114.

A group media client 102 may comprise any type of media client or display capable of and/or configured to receive and/or display streaming game data. For example, in various embodiments, the group media client 102 can comprise a television, a computer monitor, a cathode ray tube, an LED display, a plasma display, and LCD display, an OLED display, and/or any other suitable display.

An MSDGP 104 may comprise any device that can encode and/or stream media in real time or substantially real time. For example, MSDGP 104 may comprise any suitably configured media streaming and/or placeshifting device (such as, for example, the placeshifting device described in U.S. Published Patent Application No. 2006/0095471, entitled PERSONAL MEDIA BROADCASTING SYSTEM, filed Jun. 7, 2005, which is incorporated by reference in its entirety above).

Moreover, in various embodiments, an MSDGP 104 may comprise any device that includes a processor that can execute game software and/or game logic to generate game data and/or receive selected game data to execute the game logic to generate updated game data. For instance, the MSDGP 104 may comprise a processor that is communicatively coupled to a non-transitory computer-readable medium and/or memory that stores the game software and/or logic. The MSDGP 104 processor may receive and execute the stored game logic to enable game play. An MSDGP 104 may be communicatively coupled to the group media client 102.

A network 106 may comprise any computer network, such as the internet, a local area network, a wide area network, and the like. The MSDGP 104 may be communicatively coupled to the network 106 and may stream media over the network 106, as described herein, to the group media client 102 and/or to any of a plurality of personal media clients 108-114.

A personal media client 108, 110, 112, and/or 114 may comprise any device configured to and/or capable of receiving and/or displaying streaming game data. Thus, for example, a personal media client 108-114 may comprise any computing device, such as a television, a personal computer, a smartphone, a tablet computing device, a wearable computing device having a display, and the like. A personal media client 108-114 may be communicatively coupled to the network 106 and may receive, as described herein, data streamed over the network 106 by the MSDGP 104. Thus, each of the plurality of personal media clients 108-114 may be communicatively coupled through the network to the MSDGP 104.

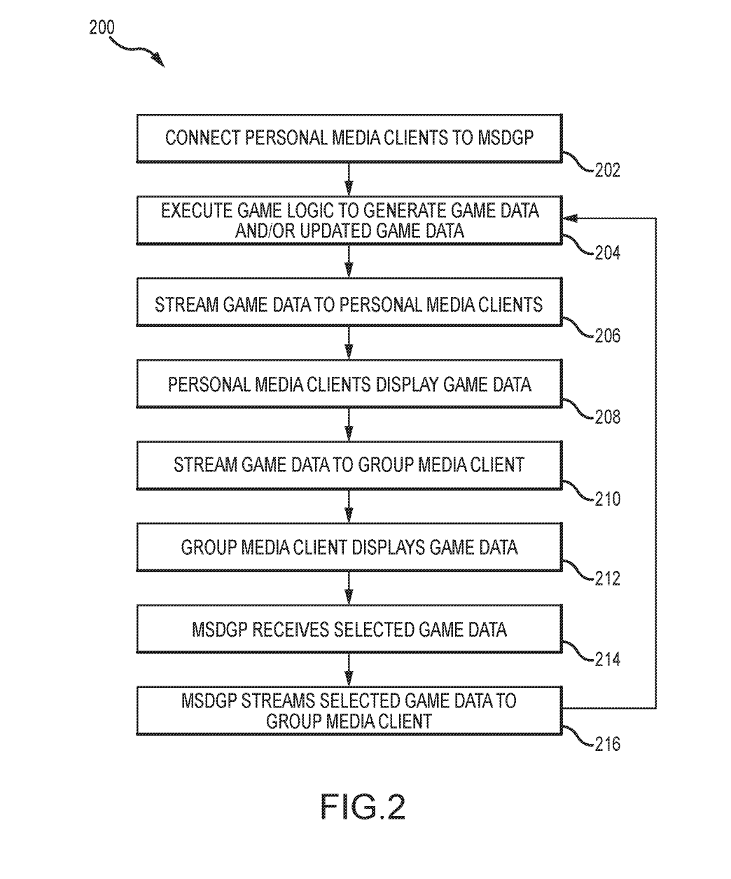

With reference to FIG. 2, a process 200 for streaming a game in real time via a placeshifting system and method, as described herein, to a group media client and a plurality of personal media clients 108-114 is shown. In various embodiments, and as described elsewhere herein, one or more of the personal media clients 108-114 may connect to the MSDGP 104 over the network 106 (step 202). The MSDGP 104 may execute gaming software or gaming logic, as described above, to enable game play. For example, the MSDGP 104 may execute gaming logic to generate game data (e.g., in the case of a poker game, and for example, the cards being dealt to each player) (step 204). The MSDGP 104 may further stream in real time the generated game data to one or more of the personal media clients 108-114 (step 206). In various embodiments, any of a variety of games may be implemented, such as, for example, any of a variety of collectible card games, any gambling, money handling, and/or betting games, any strategy and/or role playing games, and the like.

Each of the personal media clients 108-114 that receives streamed game data may, in various embodiments, display the game data (e.g., via a display that is included in the personal media client 108-114) for the game play to whom the personal media client 108-114 belongs (step 208).

Similarly, and in various embodiments, the MDSGP may stream in real time the generated game data to the group media client 102 (step 210). The group media client 102 may, like each of the personal media clients 108-114, display all or a portion of the generated game data (e.g., in the case of poker, the group media client 102 may display any type of player action or game status, such as a player bet, a betting cap, a card dealt to a player, a jackpot or pot, and the like) (step 212). Thus, each game player may view the group media client 102 as a virtual game display (e.g., a virtual poker table).

One or more of the game plays may select or otherwise act upon the received game data (e.g., in the game of poker, a game play may select a number of cards to hold and/or a number of cards to discard). The MSDGP 104 may receive in real time, from one or more of the personal media clients 108-114, the selected game data (step 214). And, in response, the MSDGP 104 may, in various embodiments, stream in real time the selected game data to the group media client 102 for display by the group media client 102 (step 216).

The MSDGP 104 may continue to execute the game logic to generate updated game data (returning until the game is complete, to step 204). The process 200 may continue, as described above, such that the MSDGP streams in real time the updated game data to the group media client 102 and/or to one or more of the personal media clients 108-114. Game plays may, as described above, continue to make game decisions, driving the generation of updated game data, until the game is completed.

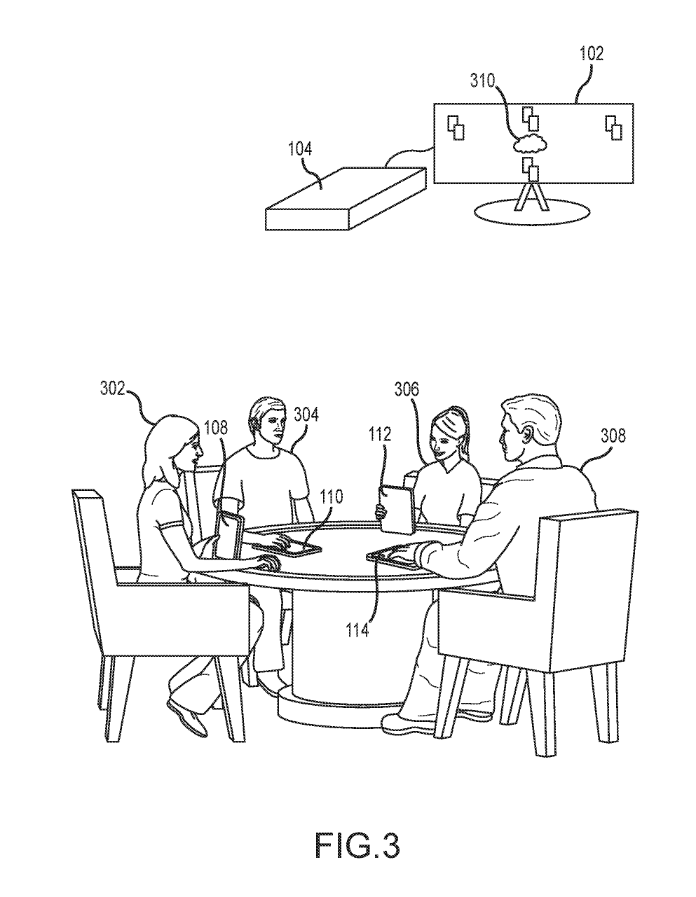

A three-dimensional representation of a group of game players playing a card game, such as poker, is shown in FIG. 3. As shown, a group of game players 302, 304, 306, and/or 308 may play a game as a group. Each game player 302-308 may possess a personal media client 108-114, and as described herein, each player may engage in game play via the respective personal media client 108-114 of the game player. Moreover, as described herein, each game play may view a group media client 102 to gain an overview of the public aspects of the game (e.g., in poker, for example, the jackpot 310).

Thus, the systems and methods disclosed herein may enable a centralized game play format (i.e., in that the MSDGP 104 executes game logic, rather than each personal media client 108-114). Each game player may review a variety of real time streamed game data by way of the personal media client 108-114 associated with or belonging to that game player and communicate, for processing by the MSDGP 104, selected game data. The MSDGP 104 may execute game logic based upon the selected game data to generate updated game data, and this updated game data may be streamed in real time, as described herein, via placeshifting systems and methods, to the group media client 102 and/or to one or more of the personal media clients 108-114, and game play may continue in this repeated or recursive fashion until the game is complete.

The terms “exemplary” and “example” are used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is presently claimed is:

1. A process for streaming a game in real time to a group media client and a plurality of personal media clients, each personal media client belonging to a player of the game, the process comprising:
executing, by a media streaming device and game processor (“MSDGP”), game logic to generate and encode game data;
streaming, by the MSDGP and in real time, the game data to the group media client, the group media client visible to each player of the game; and
streaming, by the MSDGP and in real time, the encoded game data to at least one of the plurality of personal media clients.

2. The process of claim 1, further comprising, receiving, by the MSDGP and from at least one of the plurality of personal media clients, selected game data.

3. The process of claim 1, further comprising streaming, by the MSDGP, selected game data to the group media client.

4. The process of claim 2, further comprising streaming, by the MSDGP, the selected game data to the group media client.

5. The process of claim 1, wherein the group media client displays the game data.

6. The process of claim 3, wherein the group media client displays the selected game data.

7. The process of claim 2, further comprising executing, by the MSDGP, the game logic in response to the receiving the selected game data to generate updated game data.

8. The process of claim 7, further comprising streaming, by the MSDGP, the updated game data to at least one of the plurality of personal media clients.

9. The process of claim 7, further comprising streaming, by the MSDGP, the updated game data to the group media client.

10. The process of claim 7, further comprising streaming, by the MSDGP, the updated game data to the plurality of personal media clients and to the group media client.

11. A system for streaming a game to a group media client and a plurality of personal media clients, each personal media client belonging to a player of the game, the system comprising:
a media streaming device and game processor (“MSDGP”) that streams encoded game media comprising game data to a group media client communicatively coupled to the MSDGP and the plurality of personal media clients, the MSDGP:
executing game logic to generate the game data,
streaming the game data to the group media client, and
streaming the game data to each of the plurality of personal media clients.

12. The system of claim 11, the MSDGP receiving from at least one of the plurality of personal media clients, selected game data.

13. The system of claim 11, the MSDGP streaming selected game data to the group media client.

14. The system of claim 12, the MSDGP streaming the selected game data to the group media client.

15. The system of claim 11, wherein the group media client displays the game data.

16. The system of claim 13, wherein the group media client displays the selected game data.

17. The system of claim 12, the MSDGP executing the game logic in response to the receiving the selected game data to generate updated game data.

18. The system of claim 17, the MSDGP streaming the updated game data to at least one of the plurality of personal media clients.

19. The system of claim 17, the MSDGP streaming the updated game data to the group media client.

20. A media streaming device and game processor (“MSDGP”) comprising a tangible, non-transitory, computer-readable medium, the MSDGP:
executing game logic to generate game data,
streaming the game data to a group media client,
streaming the game data to each of a plurality of personal media clients,
receiving selected game data from each of the plurality of personal media clients,
streaming the selected game data to the group media client,
executing the game logic to generate updated game data,
streaming the updated game data to each of the plurality of personal media clients, and
streaming the updated game data to the group media client.
